(19) United States
(12) Patent Application Publication
(10) Pub. No.: US 2015/0088691 A1
(43) Pub. Date: Mar. 26, 2015

(54) SYSTEM AND METHOD FOR TOLL BACKED PAY PER CALL

(71) Applicant: Soleo Communications, Inc., Fairpoint, NY (US)

(72) Inventor: Will Fisher, Rochester, NY (US)

(73) Assignee: Soleo Communications, Inc., Fairpoint, NY (US)

(21) Appl. No.: 14/285,766

(22) Filed: May 23, 2014

Related U.S. Application Data
(60) Provisional application No. 61/826,527, filed on May 23, 2013.

(51) Int. Cl. G06Q 30/06; H04M 11/10

(52) U.S. Cl. CPC G06Q 30/0623; H04M 11/10
USPC 705/26.61

(57) ABSTRACT

The disclosed subject matter provides for the pairing of a comprehensive listings data base, such as from Directory Assistance, with the existing collect calling infrastructure to place collect calls to desirable merchants. A series of requests are made to various local business merchants, based on inquiries from consumer callers, which may be via nearly any data generation source. The system will function best when the input data includes: location information, a call back number, request category information, and request details. These collect calls are made until an appropriate merchant is found. Technologically, once established the back end then could be strapped on to multiple consumer facing points, apps, kiosks, websites, phone numbers, etc so that they might make a request for a service and be momentarily called by someone able to provide that call. Anytime, anywhere, if you need something, type it in and receive a call from the expert.

### FIELD OF THE INVENTION

This disclosure relates in general to the advertising and lead generation markets.

### BACKGROUND OF THE INVENTION

The Pay per Call market place is a subset of the advertising and lead generation markets. The pay per call market allows businesses to purchase advertising on a performance basis, thereby allowing them to manage the risk associated with advertising and allows ad agencies to balance their resources better. The most common sources of pay per call calls are calls to directory assistance (e.g., 411), web searches, and mobile advertising. One main goal of a pay per call inquiry or call is to generate a list of merchants and provide that list to the caller.

A major development hurdle in the pay per call market is the inability to pre-register a sufficiently large number of subscribing merchants. One of the limitations with pay per call directory assistance or direct merchant referral is that only a small percentage of merchants will actually subscribe to be included in the pay per call listings. While merchants consistently report that calls are the most valuable form of leads, historically those companies that sold advertising on a pay per call basis struggled to balance supply and demand. Quality control issues such as this leads to negative sentiments for paying for leads. This factor has been a hurdle for the pay per call market because the overall caller experience with directory assistance or the direct merchant referral product is diminished by not generating sufficient listings for a particular location or category within the pay per call listings. For example, a list of merchants generated by a pay per call inquiry or call containing only one plumber to serve all of New York City would not be beneficial to a caller looking to shop around for the services of a plumber. In this context, the caller will be disappointed and, as a result, be less likely to use the pay per call market again in the future.

The lack of participation in directory assistance or direct merchant referral products described above, paired with the historical failings of call tracking and the low availability of channels through which integrated tracking is available holds back the current pay per call market. A need exists for an improved pay per call product that does not have these shortcomings. This product solves a portion of this problem—the merchant pre-registration and subscription issue.

### BRIEF SUMMARY OF THE INVENTION

The following disclosure presents concepts for improving the pay per call experience. The disclosed subject matter significantly improves upon prior methods aimed at generating listings within pay per call systems. It is an object of the present disclosure to eliminate the need to pre-register or subscribe merchants in a pay per call system. Further, it is an object of the present disclosure to ensure that the income generating potential of pay per call inquiries and calls is not wasted on unsubscribed merchants.

The platform described herein enables advertisers to capitalize on the entire inventory of merchants with telephone listings without the need to form those merchant relationships in advance of a pay per call inquiry or call. Also, instead of maintaining an infrastructure for billing, account management, and sales people for local business for hundreds or thousands of localities, this platform uses an existing telecom network. An advertiser on this system could advertise anything they wanted (within the limits of the law) and, if calls are generated to a merchant via pay per call, that merchant would receive a check at the end of the month from its local telco for revenue generated by those pay per call calls.

One aspect of the disclosed subject matter is a platform neutral system.

Another aspect of the disclosed subject matter is the use of asynchronous searches.

Yet another aspect of the disclosed subject matter is the elimination of merchant pre-registration or subscription.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGURES and detailed description. It is intended that all such additional systems, methods, features and advantages that are included within this description, be within the scope of any claims filed later.

### BRIEF DESCRIPTIONS OF THE DRAWINGS

The novel features believed characteristic of the presently disclosed subject matter will be set forth in any claims that are filed later. The presently disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 depicts a flow chart of an embodiment of the present disclosure's system architecture.

FIG. 2 depicts a block diagram of an embodiment of the general components and flow of information according to the disclosed subject matter.

### DETAILED DESCRIPTION OF THE SPECIFIC EMBODIMENTS

Although described with particular reference to certain embodiments, those with skill in the arts will recognize that the disclosed subject matter has relevance to a wide variety of areas in addition to those specific examples described below.

All references, including publications, patent applications, and patents, cited herein are hereby incorporated by reference to the same extent as if each reference were individually and specifically indicated to be incorporated by reference and were set forth in its entirety herein.

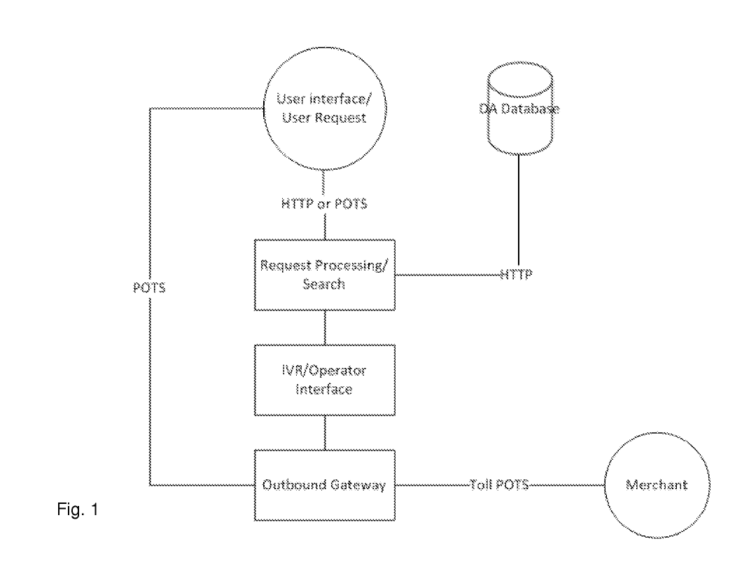

FIG. 1 depicts a flow chart of an embodiment of the present disclosure's system architecture. System calls successive merchants as collect calls until some merchant agrees to supply/offer service, wherein they are connected to requestor.

A series of requests are made to various local business merchants via collect calls placed over Plain Old Telephone Service (POTS), based on an inquiry from a user. The user inquiry is depicted in FIG. 1 as either HTTP or POTS but may be generated through a variety of other data platforms, including, but not limited to: SMS texting, e-mail, website, phone calls, etc. The system will continue to make a series of collect calls until an appropriate merchant is found.

By utilizing a comprehensive listings data base, such as from Directory Assistance, paired with the existing phone network to place collect calls to desirable merchants, the present disclosure is able to work around the problem of attracting, pre-registering and signing up merchants. This creates a much broader range of merchants available to consumers/callers via pay per call, and therefore leading to a better user experience. This collect call generating system then could be coupled to multiple consumer facing points including, but not limited to: mobile phone or computer apps or applications, kiosks, websites or web forms, search query, directory assistance call, intercept call, 800 and other phone numbers, sms, email, etc., so that consumers might make a request for a service and be momentarily called by someone able to fulfill that request.

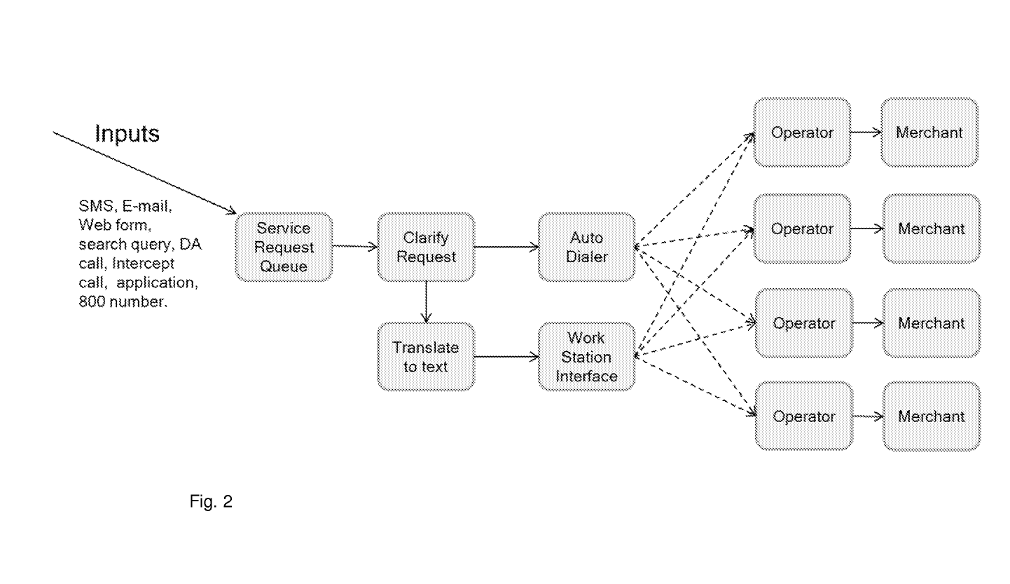

FIG. 2 depicts a block diagram of an embodiment of the general components and flow of information according to the disclosed subject matter. The consumer user inputs an inquiry to the system, which may be via nearly any data generation source, such as: mobile phone or computer apps or applications, kiosks, websites or web forms, search query, directory assistance call, intercept call, 800 and other phone numbers, sms, email, etc. The system will function best when the input data includes: location information, a call back number, request category information, and request details. The system is operable to make calls without one or the other of the request category information or request details, but the search and results will be more optimal if all input data is provided. Using request category information, the system is able to call generalists within that category. Alternatively, the system can conduct open text searches to guess at a category based upon the request details if necessary.

The input communications represent a multitude of different channels primarily falling into two types of communications: voice and text. The system is operable with both types of communications. However, it may be more efficient if one type of communication was converted into the other. In an exemplary embodiment, in the case of a phone call, the call may be transcribed and displayed on an operator's work station. Alternatively, in another exemplary embodiment, the system could also generate a Plain Old Telephone Service (POTS) call to the operator, and then play the recorded request or use a text to speech function to read the request to the operator. In both embodiments, the marginally declining quality of conversions is something that is preferably avoided. Therefore, preferably a double-linked system would work better, such that the system might place a call when there is a voice communication and that the system might also display the text on the operators screen when there is a text-based request.

The actual consumer experience varies by communication channel. However, the typical consumer experience would be something along the lines of:
“Tell us your request/problem/issue and we will call you when we find someone who can help.”

After the consumer user has entered his/her inputs and request, the typical merchant experience would be something along the lines of:
*Merchant Answers Phone*
“Hello, will you accept a collect call from John Doe? He is searching for a plumber.”
*Merchant will indicate Yes/No to accepting the collect call*

Alternatively, for a different service request, a different merchant might receive the following:
*Merchant Answers Phone*
“Hello, will you accept a collect call from Jane Doe? She is searching for someone plow her driveway this winter.”
*Merchant will indicate Yes/No to accepting the collect call*

The more information provided to the merchant, the better able the merchant will be to accept the collect call based on provided details and engage in providing services or to decline. The ultimate burden is upon the merchant to self-select the quality of the customers with whom they wish to work with; this can all be done in real-time.

The present disclosure may also be applicable in mobile advertising scenarios.

The foregoing description of the preferred embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

The detailed description set forth below in connection with the appended drawings is intended as a description of exemplary embodiments in which the presently disclosed system and method can be practiced. The term “exemplary” used throughout this description means “serving as an example, instance, or illustration,” and should not necessarily be construed as preferred or advantageous over other embodiments.

Further, although exemplary devices and schematics implementing the elements of the disclosed subject matter have been provided, one skilled in the art, using this disclosure, could develop additional hardware and/or software to practice the disclosed subject matter and each is intended to be included herein.

In addition to the above described embodiments, those skilled in the art will appreciate that this disclosure has application in a variety of arts and situations and this disclosure is intended to include the same.

What is claimed is:

1. A system, method, and/or computer readable medium as disclosed above.
